(19) United States
(12) Patent Application Publication
(10) Pub. No.: US 2026/0323057 A1
(43) Pub. Date: Oct. 15, 2026

(54) EXTENDED PALETTE CODING

(71) Applicant: GOOGLE LLC, Mountain View, CA (US)

(72) Inventors: In Suk Chong, Mountain View, CA (US); Joseph Young, Mountain View, CA (US); Aki Kuusela, Palo Alto, CA (US)

(21) Appl. No.: 19/485,417

(22) PCT Filed: May 20, 2024
(86) PCT No.: PCT/US2024/030216

§ 371 Date: Nov. 18, 2025

Related U.S. Application Data
(60) Provisional application No. 63/467,803, filed on May 19, 2023.

(51) Int. Cl. H04N 19/44; H04N 19/176; H04N 19/182; H04N 19/186; H04N 19/70

(52) U.S. Cl. CPC H04N 19/44; H04N 19/176; H04N 19/182; H04N 19/186; H04N 19/70

(57) ABSTRACT

A current block of an image is reconstructed using extended palette coding. A residual block corresponding to the current block is decoded from an encoded bitstream. For pixels of the current block, a color index is identified, and a determination is made whether the color index identifies a defined pixel value in a palette that includes multiple defined pixel values and an indicator of an undefined pixel value. The prediction block is generated by, for respective pixels, populating a pixel position of the pixel within the prediction block with the defined pixel value when the color index indicates the defined pixel value, and otherwise populating the pixel position with a pixel value interpolated using a defined pixel value of the multiple defined pixel values and another pixel value within the prediction block. The current block is reconstructed using the residual block and the prediction block.

### CROSS-REFERENCE TO RELATED APPLICATION(S)

This application claims priority to and the benefit of U.S. Provisional Application Patent Ser. No. 63/467,803, filed May 19, 2023, the entire disclosure of which is hereby incorporated by reference.

### BACKGROUND

Digital video streams may represent video using a sequence of frames or still images. Digital video can be used for various applications including, for example, video conferencing, high-definition video entertainment, video advertisements, or sharing of user-generated videos. A digital video stream can contain a large amount of data and consume a significant amount of computing or communication resources of a computing device for processing, transmission, or storage of the video data. Various approaches have been proposed to reduce the amount of data in video streams, including compression and other encoding techniques.

### SUMMARY

This disclosure relates generally to encoding and decoding video data and more particularly relates to encoding and decoding using extended palette coding.

An aspect of the teachings herein is a method for reconstructing a current block of an image. The method includes decoding, from an encoded bitstream, a residual block corresponding to the current block, for each pixel of multiple pixels of a prediction block for the current block, identifying a color index for the pixel, and determining whether the color index identifies a defined pixel value in a palette. The palette includes multiple defined pixel values and an indicator of an undefined pixel value. The method also includes generating a prediction block by, for each pixel of the multiple pixels, populating a pixel position of the pixel within the prediction block with the defined pixel value when the color index indicates the defined pixel value, and otherwise populating the pixel position with a pixel value interpolated using a defined pixel value of the multiple defined pixel values and another pixel value within the prediction block, and reconstructing the current block using the residual block and the prediction block.

In some implementations, the method includes decoding the palette from the encoded bitstream.

In some implementations, the method includes decoding, from the encoded bitstream, a palette identifier that identifies the palette from multiple palettes. The multiple palettes may be predefined palettes available to both an encoder and a decoder, or the multiple palettes may be signaled in the bitstream.

In some implementations, determining whether the color index identifies the defined pixel value in a palette includes determining whether the color index matches a palette index of the palette that is associated with the defined pixel value.

In some implementations, identifying the color index includes entropy decoding the color index from the encoded bitstream.

In some implementations, the method includes interpolating the pixel value using two pixel values of the multiple defined pixel values.

In some implementations, the method includes interpolating the pixel value using a pixel value interpolated using the multiple defined pixel values.

In some implementations, populating pixel positions for each of the multiple pixels having a defined pixel value occurs before populating those of the multiple pixels having an undefined pixel value by interpolation.

In some implementations, the method includes decoding, from the encoded bitstream, an interpolation mode for interpolating pixel values for the pixel positions of the prediction block having a color index that indicates that pixels in the pixel positions have the undefined pixel value.

An aspect of the teachings herein is an apparatus for reconstructing a current block of an image that includes a processor configured to perform any of the methods described herein.

An aspect of the teachings herein is a non-transitory computer-readable storage medium having stored thereon instructions that, when executed, cause a processor to perform any of the methods described herein.

An aspect of the teachings herein is a non-transitory computer-readable storage medium having stored thereon an encoded bitstream, the encoded bitstream including a residual block corresponding to a current block in an image, and, for each pixel of multiple pixels of a prediction block for the current block, a color index for entries in a palette that includes multiple defined pixel values and an indicator of an undefined pixel value.

In some implementations, the encoded bitstream includes the palette.

In some implementations, the encoded bitstream includes an interpolation mode for interpolating pixel values for the pixel positions of the prediction block having a color index that indicates that respective pixels in the pixel positions have the undefined pixel value.

These and other aspects of the present disclosure are disclosed in the following detailed description of the embodiments, the appended claims, and the accompanying figures.

### BRIEF DESCRIPTION OF THE DRAWINGS

The description herein refers to the accompanying drawings described below wherein like reference numerals refer to like parts throughout the several views unless otherwise noted.

FIG. 1 is a schematic of a video encoding and decoding system.

FIG. 2 is a block diagram of an example of a computing device that can implement a transmitting station or a receiving station.

FIG. 3 is a diagram of a typical video stream to be encoded and subsequently decoded.

FIG. 4 is a block diagram of an encoder according to implementations of this disclosure.

FIG. 5 is a block diagram of a decoder according to implementations of this disclosure.

FIG. 6 is a flowchart diagram of a process for reconstructing a current block of an image using extended palette coding according to an implementation of this disclosure.

FIGS. 7A and 7B are diagrams of a block used to explain the extended palette coding of FIG. 6.

### DETAILED DESCRIPTION

A video stream can be compressed by a variety of techniques to reduce the bandwidth required to transmit or store the video stream. A video stream can be encoded into a bitstream (i.e., a compressed bitstream), which involves compression. The compressed bitstream can then be transmitted to a decoder that can decode or decompress the compressed bitstream to prepare it for viewing or further processing. Compression of the video stream often exploits spatial and temporal correlation of video signals through spatial and/or motion-compensated prediction.

Some known techniques include spatial prediction, also referred to as intra prediction, which uses previously encoded and decoded pixels from at least one block adjacent to a current block to be encoded to generate a block (also called a prediction block) that resembles the current block. By encoding the intra prediction mode and the difference between the two blocks (i.e., the current block and the prediction block), a decoder receiving the encoded signal can re-create the current block. Other known techniques include motion-compensated prediction, also referred to as inter prediction, which uses one or more motion vectors to generate a prediction block that resembles a current block to be encoded using previously encoded and decoded pixels. By encoding the motion vector(s) and the difference between the two blocks (i.e., the current block and the prediction block), a decoder receiving the encoded signal can re-create the current block. The difference between the two blocks, whether generated using inter prediction or intra prediction, is referred to herein as the residual or the residual block.

Palette coding may be considered a special case of intra prediction. Instead of using pixel values from other blocks within the frame to generate the prediction block, pixel values may be signaled as indexes into a color palette, e.g., for clear-cut synthetic pixels like text in white background or graphic content that has a limited set of pixel values with clear cut edges. One drawback to using palette coding is that the required color palette may be relatively large. For example, text with anti-aliased edges requires more pixel values to be coded than text without anti-aliased edges.

Techniques for extended palette coding are described herein that use both undefined pixels with defined pixel values in a color palette. By doing so, a reduction in the number of color tables (e.g., values) to be transmitted for a prediction unit (e.g., a current block) and in the number of bits required to signal the color index of each pixel. Further details of these techniques are described hereinbelow after a description of the environment in which the teachings herein may be implemented.

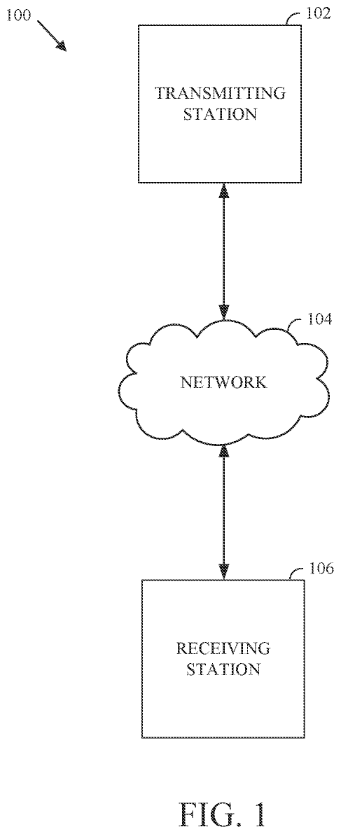

FIG. 1 is a schematic of a video encoding and decoding system 100. A transmitting station 102 can be, for example, a computer having an internal configuration of hardware such as that described in FIG. 2. However, other suitable implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102 and the encoded video stream can be decoded in the receiving station 106. The network 104 can be, for example, the Internet. The network 104 can also be a local area network (LAN), wide area network (WAN), virtual private network (VPN), cellular telephone network or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having a non-transitory storage medium or memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used, e.g., a video streaming protocol based on the Hypertext Transfer Protocol (HTTP).

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits its own video bitstream to the video conference server for decoding and viewing by other participants.

FIG. 2 is a block diagram of an example of a computing device 200 that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A CPU 202 in the computing device 200 can be a central processing unit. Alternatively, the CPU 202 can be any other type of device, or multiple devices, capable of manipulating or processing information now existing or hereafter developed. Although the disclosed implementations can be practiced with one processor as shown, e.g., the CPU 202, advantages in speed and efficiency can be achieved using more than one processor.

A memory 204 in computing device 200 can be a read only memory (ROM) device or a random-access memory (RAM) device in an implementation. Any other suitable type of storage device or non-transitory storage medium can be used as the memory 204. The memory 204 can include code and data 206 that is accessed by the CPU 202 using a bus 212. The memory 204 can further include an operating system 208 and application programs 210, the application programs 210 including at least one program that permits the CPU 202 to perform the methods described here. For example, the application programs 210 can include applications 1 through N, which further include a video coding application that performs the methods described here. Computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the CPU 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display or light emitting diode (LED) display, such as an organic LED (OLED) display.

The computing device 200 can also include or be in communication with an image-sensing device 220, for example a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the CPU 202 and the memory 204 of the computing device 200 as being integrated into a single unit, other configurations can be utilized. The operations of the CPU 202 can be distributed across multiple machines (wherein individual machines can have one or more of processors) that can be coupled directly or across a local area or other network. The memory 204 can be distributed across multiple machines such as a network-based memory or memory in multiple machines performing the operations of the computing device 200. Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

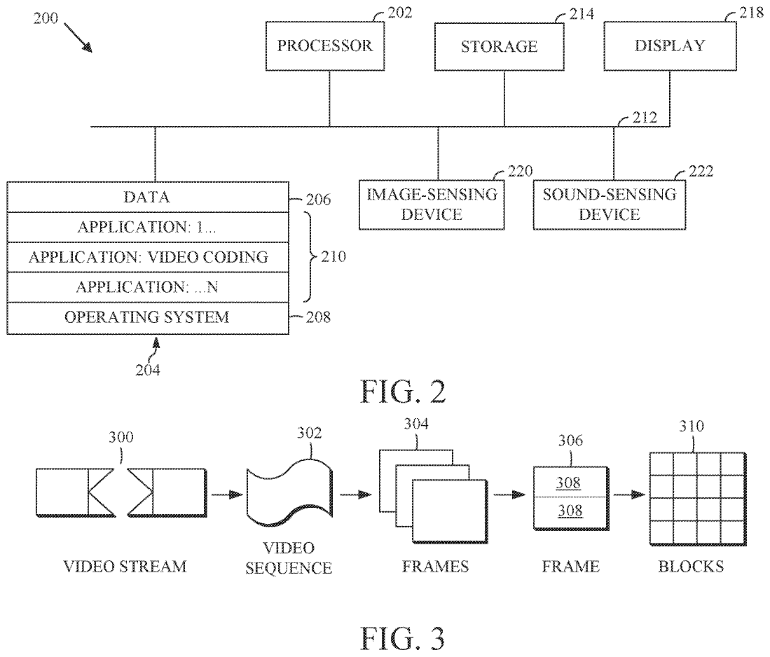

FIG. 3 is a diagram of an example of a video stream 300 to be encoded and subsequently decoded. The video stream 300 includes a video sequence 302. At the next level, the video sequence 302 includes multiple adjacent frames 304. While three frames are depicted as the adjacent frames 304, the video sequence 302 can include any number of adjacent frames 304. The adjacent frames 304 can then be further subdivided into individual frames, e.g., a frame 306. At the next level, the frame 306 can be divided into a series of planes or segments 308. The segments 308 can be subsets of frames that permit parallel processing, for example. The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, 16×16 pixels in the frame 306. The blocks 310 can also be arranged to include data from one or more segments 308 of pixel data. The blocks 310 can also be of any other suitable size such as 4×4 pixels, 8×8 pixels, 16×8 pixels, 8×16 pixels, 16×16 pixels, or larger. Unless otherwise noted, the terms block and macroblock are used interchangeably herein.

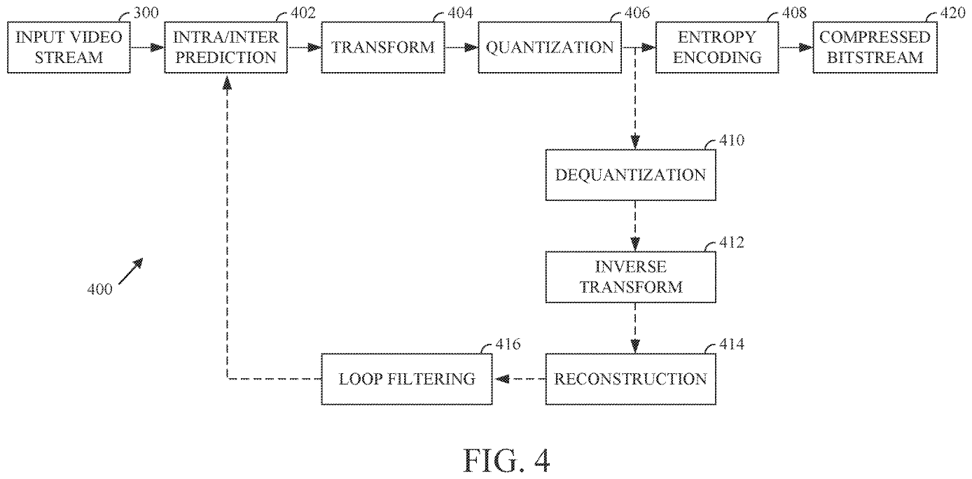

FIG. 4 is a block diagram of an encoder 400 according to implementations of this disclosure. The encoder 400 can be implemented, as described above, in the transmitting station 102 such as by providing a computer software program stored in memory, for example, the memory 204. The computer software program can include machine instructions that, when executed by a processor such as the CPU 202, cause the transmitting station 102 to encode video data in the manner described in FIG. 4. The encoder 400 can also be implemented as specialized hardware included in, for example, the transmitting station 102. The encoder 400 may be a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

When the video stream 300 is presented for encoding, respective frames 304, such as the frame 306, can be processed in units of blocks. At the intra/inter prediction stage 402, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames.

Next, still referring to FIG. 4, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated. The quantized transform coefficients are then entropy encoded by the entropy encoding stage 408. The entropy-encoded coefficients, together with other information used to decode the block, which may include for example the type of prediction used, transform type, motion vectors and quantizer value, are then output to the compressed bitstream 420. The compressed bitstream 420 can be formatted using various techniques, such as variable length coding (VLC) or arithmetic coding. The compressed bitstream 420 can also be referred to as an encoded video stream or encoded video bitstream, and the terms will be used interchangeably herein.

The reconstruction path in FIG. 4 (shown by the dotted connection lines) can be used to ensure that the encoder 400 and a decoder 500 (described below) use the same reference frames to decode the compressed bitstream 420. The reconstruction path performs similar functions to those functions that take place during the decoding process that are discussed in more detail below, including dequantizing the quantized transform coefficients at the dequantization stage 410 and inverse transforming the dequantized transform coefficients at the inverse transform stage 412 to produce a derivative residual block (also called a derivative residual). At the reconstruction stage 414, the prediction block that was predicted at the intra/inter prediction stage 402 can be added to the derivative residual to create a reconstructed block. The loop filtering stage 416 can be applied to the reconstructed block to reduce distortion such as blocking artifacts.

Other variations of the encoder 400 can be used to encode the compressed bitstream 420. For example, a non-transform-based encoder can quantize the residual signal directly without the transform stage 404 for certain blocks or frames. In another implementation, an encoder can have the quantization stage 406 and the dequantization stage 410 combined in a common stage.

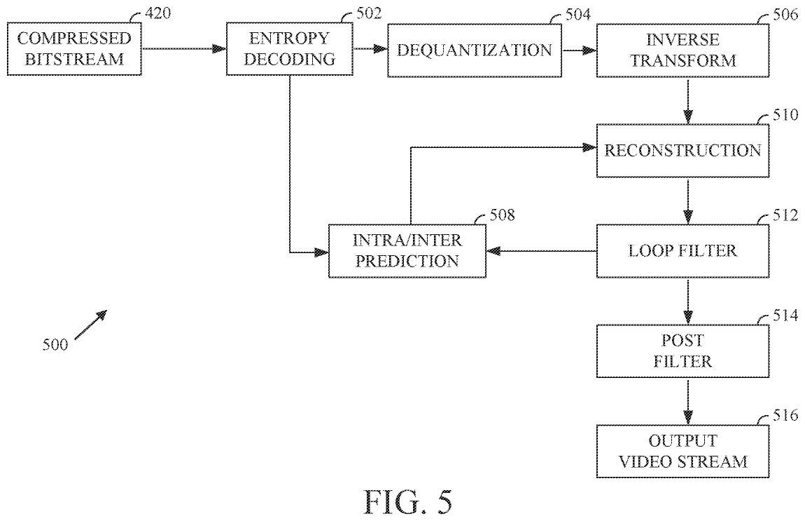

FIG. 5 is a block diagram of a decoder 500 according to implementations of this disclosure. The decoder 500 can be implemented in the receiving station 106, for example, by providing a computer software program stored in the memory 204. The computer software program can include machine instructions that, when executed by a processor such as the CPU 202, cause the receiving station 106 to decode video data in the manner described herein. The decoder 500 can also be implemented in hardware included in, for example, the transmitting station 102 or the receiving station 106. The decoder 500 may be a hardware decoder.

The decoder 500, like the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512 and a post filtering stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400, e.g., at the intra/inter prediction stage 402. At the reconstruction stage 510, the prediction block can be added to the derivative residual to create a reconstructed block. The loop filtering stage 512 can be applied to the reconstructed block to reduce blocking artifacts.

Other filtering can be applied to the reconstructed block. In this example, the post filtering stage 514 can be a deblocking filter that is applied to the reconstructed block to reduce blocking distortion, and the result is output as the output video stream 516. The output video stream 516 can also be referred to as a decoded video stream, and the terms will be used interchangeably herein. Other variations of the decoder 500 can be used to decode the compressed bitstream 420. For example, the decoder 500 can produce the output video stream 516 without the post filtering stage 514.

As discussed briefly above, in some implementations of a codec, the encoder and decoder may use palette coding. For example, in the arrangement of FIGS. 4 and 5, the coding tables (e.g., values and respective index values) for a prediction unit (e.g., a block) and the index for each pixel may be entropy coded, such as at the entropy encoding stage 408, directly into an encoded bitstream, such as the compressed bitstream 420. Thereafter, the decoder may receive the encoded bitstream and entropy decode the coding tables and the indexes. The indexes identify the pixel values from the coding tables to reconstruct the block.

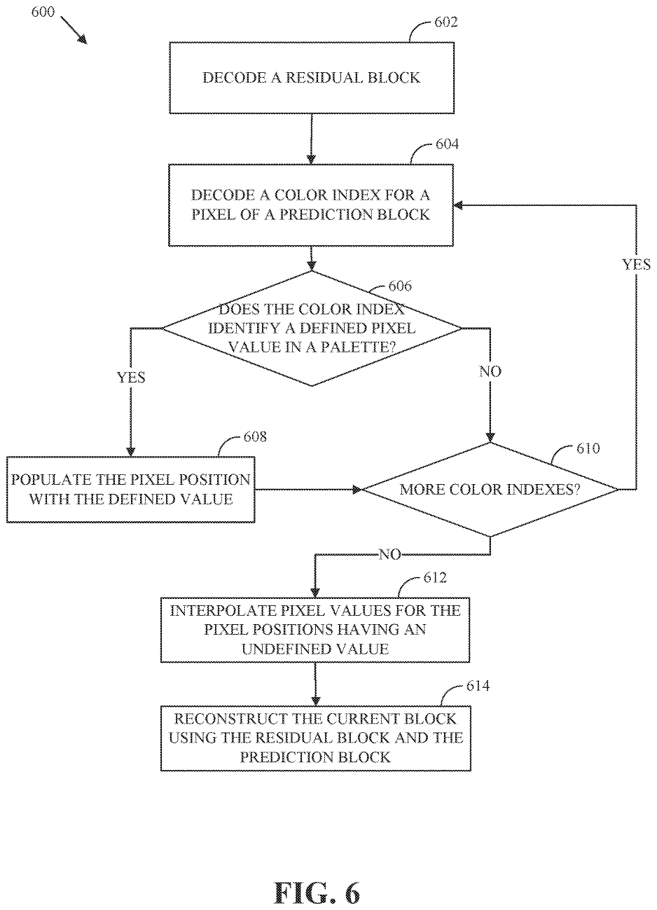

FIG. 6 is a flowchart diagram of a method or process 600 for reconstructing a current block of an image using extended palette coding according to an implementation of this disclosure. The process 600 can be implemented, for example, as a software program that may be executed by computing devices such as the transmitting station 102 or the receiving station 106. The software program can include machine-readable instructions that may be stored in a memory such as the memory 204 or the secondary storage 214, and that, when executed by a processor, such as CPU 202, may cause the computing device to perform the process 600. The process 600 may be implemented in one or more stages of a decoder, such as the decoder 500. The process 600 can be implemented using specialized hardware or firmware. Multiple processors, memories, or both, may be used. The process 600 may be repeated for each block of the frame in the encoded bitstream that was encoded using an extended palette.

At operation 602, the process 600 decodes a residual block corresponding to a current block of an image. In this example, the current block was encoded using the extended palette (also called an extended color palette) described in more detail below. The image can be a still image or a frame of a video sequence. Although the term color may be used with respect to the palette herein, the encoded block may correspond to a block in any color plane, such as a luma block including intensity values.

At a decoder, a residual block can be reconstructed by, in some implementations, entropy decoding quantized transform coefficients corresponding to the block from an encoded bitstream, such as described with respect to entropy decoding the compressed bitstream 420 at the entropy decoding stage 502. Then, the quantized transform coefficients are dequantized, such as described with respect to the dequantization stage 504, and the dequantized transform coefficients are inverse transformed, such as described with respect to the inverse transform stage 506.

The process 600 next begins generation of a prediction block for the current block. Generation of the prediction block uses color indexes for the prediction block that are obtained from the encoded bitstream, such as from a header for the current block within the bitstream. A color index refers to an entry in an extended palette described herein, which entries may also be referred to as color coding tables.

At operation 604, the process 600 identifies a color index for a pixel of a prediction block. Any number of methods can be used to identify a color index so long as the encoder that generated the encoded bitstream and the decoder decoding the encoded bitstream use the same method. For example, the process 600 may decode the color index by entropy decoding the color index from the bitstream. In some implementations, a binary token tree can be used to decode the color index. In some implementations, an alphabet of non-binary symbols can be used to decode the color index. In some implementations, decoding the color index can be done by context-adaptive binary arithmetic coding (CABAC).

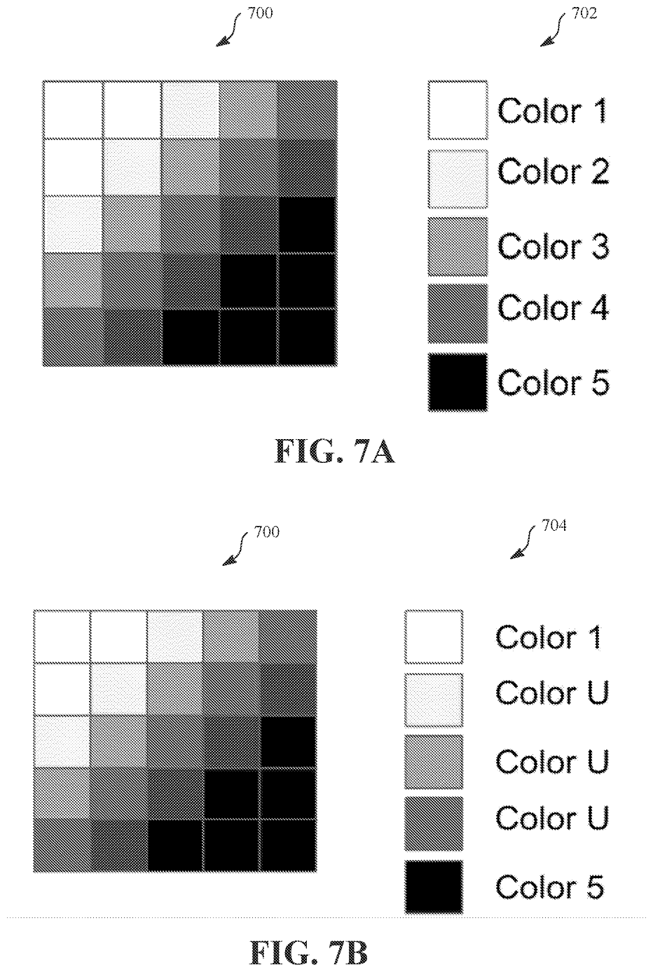

At operation 606, the process 600 queries whether the color index identifies a defined pixel value in the extended palette. Alternatively, the process 600 can query whether the color index identifies an undefined pixel value in the extended palette. An undefined pixel value in an extended palette is explained with reference to FIGS. 7A and 7B.

As can be seen from FIGS. 7A and 7B, the block 700 is a 5×5 block with twenty-five pixels, each having one of five colors (also referred to pixel values or color values herein). The block 700 is an example of an input block to be encoded at an encoder and subsequently reconstructed at a decoder. The colors may have a bit depth of 8 bits or 10 bits or may have another bit depth.

One drawback to using palette coding is that the required color palette may be relatively large. For example, text with anti-aliased edges requires more pixel values to be coded than text without anti-aliased edges. This can be seen with reference to the example of FIG. 7A. The values of pixels in the block 700 may be identified by a respective index into a color palette as shown by the mapping 702. Pixels of the block 700 at positions (0,0), (1,0), and (0,1) have color 1, pixels of the block 700 at positions (0,2), (2,0), and (1,1) have color 2, pixels of the block 700 at positions (0,3), (3,0), (1,2), and (2,1) have color 3, pixels of the block 700 at positions (0,4), (4,0), (1,4), (4,1), (1,3), (3,1), (2,2), (2,3), and (3,2) have color 4, and pixels of the block 700 at positions (4,4), (4,2), (2,4), (4,3), (3,4), and (3,3) have color 5. Color 1 has a value of 0, for example, while color 5 may have a value of 255. Conventionally, palette coding could transmit 5 color coding tables corresponding to the 5 color pixel values with respective palette indexes. Depending upon the technique used for coding, an encoder requires about log₂(5) bits to signal a color index for each pixel of the block 700. This is a relatively large palette for a relatively small block.

According to the teachings herein, an extended color palette (or more simply extended palette, color palette, or palette) comprises color tables having defined pixel values, more specifically at least two defined pixel values, with respective palette indexes and an identifier for an undefined pixel value, that is, an identifier that indicates that the palette does not include a defined value for a pixel, with a palette index. The palette described herein is referred to as an extended palette because the palette can be used for coding more values than its number of entries. This can be seen with reference to the example of FIG. 7B.

In FIG. 7B, the values of pixels in the block 700 may be identified by a respective index into the extended palette as shown by the mapping 704. The mapping 704 shows that the extended palette includes two defined pixel values—color 1 and color 5—and one indicator of an undefined pixel value. An undefined pixel value means that the color value of the pixel in the block does not have a corresponding defined pixel value in the palette. In the example of FIG. 7B, those pixels of the block 700 that do not have the value of color 1 or the value of color 5 are identified with an index having (associated with, etc.) an undefined pixel value (color U in FIG. 7). Thus, extended palette coding in this example transmits 3 color coding tables corresponding to the 2 color pixel values with respective palette indexes and one undefined color value with a palette index, and pixels in the block 700 are associated with one of the three palette indexes in the encoded bitstream, such as (1,2,U). Depending upon the technique used for coding, an encoder requires about log₂ (3) bits to signal a color index for each pixel of the block 700. This reduces signaling costs of both a palette and the pixels of the block 700.

Referring again to FIG. 6, whether the color index indicates a defined pixel value or defined color value or whether the color index indicates an undefined pixel value at operation 606 may be determined by comparing color index as decoded to the palette indexes of the extended palette. This may include determining whether the color index matches a palette index of the palette that is associated with the defined pixel value. Although not shown in FIG. 6, the palette may be sent in a header of a prediction unit, such as the block 700, or a larger portion of the image, such as a largest coding unit, superblock, slice, etc., and may be decoded (e.g., by entropy decoding) before the process 600 begins decoding the color indexes at 604.

If the process 600 determines that the color index indicates (identifies, determines, etc.) a defined pixel value in the palette in response to the query at operation 606, the process 600 advances to operation 608 to populate the corresponding pixel position of the prediction block with the defined pixel value. If not, the corresponding pixel position remains unpopulated. In some implementations, the corresponding pixel position may be stored with an indication of having an unknown pixel value. For example, a predefined symbol may be used to populate the corresponding pixel position. Regardless of what the color index is, the process 600 advances to operation 610 to determine whether there are more color indexes to decode for further pixels of the prediction block. If there are more color indexes, the process 600 returns to operation 604. Operation 604, operation 606, and, where applicable, operation 608 are performed until there are no further color indexes in response to the query of operation 610. The color indexes may be decoded in any scan order in which they are encoded into the bitstream.

When there are no further color indexes to decode, the process 600 advances to operation 612. At operation 612, after all pixels of the current block are processed, the reconstruction of the prediction block is completed by interpolating pixel values for the pixel positions having an undefined value.

How to interpolate those pixels with an undefined pixel value at operation 612 may be signaled by an encoder at the frame level (e.g., in the frame header), may be signaled at the block level (e.g., in the block header), or may be signaled in some other header, such as at a slice level. More than one technique for interpolating pixels may be signaled at the frame level, and an index may be signaled at the block or slice level identifying which interpolation to perform. The decoder can subsequently decode these symbols from the bitstream for use at operation 612.

The following is a description of the different ways that the interpolation may be performed at operation 612. The technique used to interpolate the pixel values may be referred to as an interpolation mode, As will be clear from the descriptions below, the techniques, and hence the different interpolation modes, can be used separately or together.

The interpolation may use an interpolation filter that depends on the gap between two neighboring pixels with defined pixel values, whether the defined pixel values are identified by a color index or are previously interpolated pixel values. For example, if there are multiple pixels n with an undefined color value between two neighboring pixels, an n-tap interpolation filter may be used that weights the two defined pixel values for each pixel of the multiple pixels.

The direction of interpolation may be either inferred or signaled. In an example, the direction of interpolation may be inferred based on a neighboring prediction direction (e.g., for intra predicted neighbors) or based on a neighboring interpolation direction. In an example, the direction of interpolation may be explicitly signaled at the block level (e.g., in a block header), the frame level (e.g., in a frame header), or some other level. An interpolation filter may be applied vertically, horizontally, or diagonally. In a variation, the interpolation filter may be applied in two directions, such as vertically followed by horizontally or horizontally followed by vertically. In another variation, more than one interpolation filter may be used, such as one for each direction.

In some implementations, the kernel for interpolation (e.g., the filter coefficients) can be either inferred or signaled in a header (e.g., at the frame, slice, or block level). Various kernels may be predefined between the encoder and decoder such that an index is signaled to identify the kernel to be used.

A kernel may use linear interpolation between N neighboring pixels. For example, a linear interpolation may result in a predicted pixel value Pred by summing the product of a filter coefficient (coeff_i) and a neighboring pixel value (neighboring_pixel_i) for each pixel i of the N pixels such that Pred=sum_i(coeff_i*neighboring_pixel_i). A kernel may use any predefined way for the non-linear prediction of pixels according to a function such that a predicted pixel value Pred=function (N neighboring pixels).

The interpolation to obtain color values for the undefined pixel values (e.g., for color U pixels) may use different options as referenced briefly above. In one option, interpolation may be performed using only explicitly defined color pixels (for example, the pixels with color 1 or color 5). In another option, progressive interpolation may be performed-that is, previously interpolated pixel values may be used. In an example described using FIG. 7B, pixels on the boundary of the block may be first predicted using color 1 and color 5. Thereafter, the remaining pixels may be predicted/interpolated using the already-predicted pixel values.

In this example, pixel positions having an undefined pixel value remain unpopulated until all pixel positions of the prediction block having defined pixel values are populated. This is desirable but not necessary. Interpolation may be repeatedly performed after each of multiple groups of certain pixel positions are populated with defined pixel values, such as a column or a row. More specifically, in some implementations, and depending upon the interpolation mode (or interpolation function or operation) used and what pixels with defined values are already populated within the block, the interpolation at operation 612 may be performed for at least one pixel position after operation 606 indicates that the current pixel has an undefined pixel value. For example, one or more pixel positions along a row that have an undefined value may be interpolated before proceeding to the next row.

At the end of operation 612, all pixel positions of the prediction block are populated. At operation 614, the current block is reconstructed using the prediction block and the residual block decoded at operation 602. The process 600 may be completed for each block of an image that is encoded using an extended palette. As mentioned above, more than one palette may be used. Accordingly, the process 600 may be performed using different extended palettes or the same extended palette for different blocks of an image.

Techniques by which an encoder may select which of multiple pixel values of the current block comprise the defined pixel values for interpolation are not particularly limited. In the example shown, the lowest and highest 8-bit pixel values are used. This is not required. In some implementations, more than two pixel values may be used for the defined color values. For example, the median pixel value may be used in addition to the lowest and highest pixel values. Similarly, the techniques by which an encoder may determine an interpolation mode (e.g., a kernel and filter direction or other parameters used for interpolation) for a particular block are not particularly limited. For example, multiple predefined kernels may tested to determine which results in the fewest number of bits to represent the pixel values of the current block given the defined pixel values.

As described herein, by using an extended color palette that is formed of a limited number of defined pixel values and an undefined pixel value that can take multiple pixel values by interpolation, fewer pixels are needed to represent the pixel values of the current block in the bitstream.

For simplicity of explanation, the processes herein are depicted and described as a series of steps or operations. However, the steps or operations in accordance with this disclosure can occur in various orders and/or concurrently. Additionally, other steps or operations not presented and described herein may be used. Furthermore, not all illustrated steps or operations may be required to implement a method in accordance with the disclosed subject matter.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations of the transmitting station 102 and/or the receiving station 106 (and the algorithms, methods, instructions, etc., stored thereon and/or executed thereby, including by the encoder 400 and the decoder 500) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using an apparatus, such as a general-purpose computer or general-purpose processor with a computer program that, when executed, carries out any of the respective methods, algorithms and/or instructions described herein. In addition, or alternatively, for example, a special purpose computer/processor can be utilized that contains other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server and the receiving station 106 can be implemented on a device separate from the server, such as a hand-held communications device. In this instance, the transmitting station 102 can encode content using an encoder 400 into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device and/or a device including an encoder 400 may also include a decoder 500.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described to allow easy understanding of the present invention and do not limit the present invention. On the contrary, the invention is intended to cover various modifications and equivalent arrangements included within the scope of the appended claims, which scope is to be accorded the broadest interpretation to encompass all such modifications and equivalent structure as is permitted under the law.

1. A method for reconstructing a current block of an image, comprising:
decoding, from an encoded bitstream, a residual block corresponding to the current block;
for each pixel of multiple pixels of a prediction block for the current block:
identifying a color index for the pixel; and
determining whether the color index identifies a defined pixel value in a palette, wherein the palette includes multiple defined pixel values and an indicator of an undefined pixel value;
generating a prediction block by, for each pixel of the multiple pixels:
populating a pixel position of the pixel within the prediction block with the defined pixel value when the color index indicates the defined pixel value, and otherwise populating the pixel position with a pixel value interpolated using a defined pixel value of the multiple defined pixel values and another pixel value within the prediction block; and
reconstructing the current block using the residual block and the prediction block.

2. The method of claim 1, comprising:
decoding the palette from the encoded bitstream.

3. The method of claim 1, comprising:
decoding, from the encoded bitstream, a palette identifier that identifies the palette from multiple palettes.

4. The method of claim 3, wherein the multiple palettes are predefined palettes available to both an encoder and a decoder.

5. The method of claim 1, wherein determining whether the color index identifies the defined pixel value in a palette comprises determining whether the color index matches a palette index of the palette that is associated with the defined pixel value.

6. The method of claim 1, wherein identifying the color index comprises entropy decoding the color index from the encoded bitstream.

7. The method of claim 1, comprising:
interpolating the pixel value using two pixel values of the multiple defined pixel values.

8. The method of claim 1, comprising:
interpolating the pixel value using a pixel value interpolated using the multiple defined pixel values.

9. The method of claim 1, wherein populating pixel positions for each of the multiple pixels having a defined pixel value occurs before populating those of the multiple pixels having an undefined pixel value by interpolation.

10. The method of claim 1, comprising:
decoding, from the encoded bitstream, an interpolation mode for interpolating pixel values for the pixel positions of the prediction block having a color index that indicates that pixels in the pixel positions have the undefined pixel value.

11. (canceled)

12. (canceled)

13. A non-transitory computer-readable storage medium having stored thereon an encoded bitstream, the encoded bitstream including a residual block corresponding to a current block in an image, and, for each pixel of multiple pixels of a prediction block for the current block, a color index for entries in a palette that includes multiple defined pixel values and an indicator of an undefined pixel value.

14. The non-transitory computer-readable storage medium of claim 13, wherein the encoded bitstream includes the palette.

15. The non-transitory computer-readable storage medium of one of claim 13, wherein the encoded bitstream includes an interpolation mode for interpolating pixel values for pixel positions of the prediction block having a color index that indicates that respective pixels in the pixel positions have the undefined pixel value.

16. The non-transitory computer-readable storage medium of claim 15, wherein the interpolation mode indicates that a pixel value is to be interpolated using a previously interpolated pixel value.

17. The non-transitory computer-readable storage medium of claim 13, wherein the encoded bitstream further includes a palette identifier that identifies the palette from a plurality of palettes.

18. The non-transitory computer-readable storage medium of claim 13, wherein the multiple defined pixel values in the palette utilize two defined pixel values.

19. An apparatus for reconstructing a current block of an image, comprising:
a memory storing instructions; and
a processor coupled to the memory, wherein the instructions, when executed by the processor, configure the processor to:
decode, from an encoded bitstream, a residual block corresponding to the current block;
for each pixel of a plurality of pixels of a prediction block for the current block:
identify a color index for the pixel; and
determine whether the color index identifies a defined pixel value in a palette, wherein the palette includes multiple defined pixel values and an indicator of an undefined pixel value;
generate a prediction block by, for each pixel of the multiple pixels:
populate a pixel position of the pixel within the prediction block with the defined pixel value when the color index indicates the defined pixel value, and otherwise populate the pixel position with a pixel value interpolated using a defined pixel value of the multiple defined pixel values and another pixel value within the prediction block; and
reconstruct the current block using the residual block and the prediction block.

20. The apparatus of claim 19, wherein the processor is further configured to decode, from the encoded bitstream, an interpolation mode for interpolating pixel values for the pixel positions of the prediction block having a color index that indicates that pixels in the pixel positions have the undefined pixel value.

21. The apparatus of claim 20, wherein the interpolation mode indicates that a pixel value is to be interpolated using a previously interpolated pixel value.

22. The apparatus of claim 19, wherein populating pixel positions for each of the multiple pixels having a defined pixel value occurs before populating those of the multiple pixels having an undefined pixel value by interpolation.
